(19) United States
(12) Patent Application Publication
(10) Pub. No.: US 2009/0077195 A1
(43) Pub. Date: Mar. 19, 2009

(54) Method and system for accessing audio/visual content

(75) Inventors: Simon J. Gibbs, San Jose, CA (US); Mithun Sheshagiri, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/901,931

(22) Filed: Sep. 19, 2007

(51) Int. Cl. G06F 15/16

(52) U.S. Cl. 709/217

(57) ABSTRACT

A method and system for accessing audio/visual content is provided. Such access involves initiating a download of selected content over a communication link, for display on a display device, and monitoring the download status to detect download conditions that may lead to a delay in the display of the selected content. Then, upon detecting download conditions that may lead to delay in display of the selected content, displaying alternate available content on the display device.

### FIELD OF THE INVENTION

The present invention relates to providing access to video content, and in particular to providing access to audio/video (A/V) content for display.

### BACKGROUND OF THE INVENTION

The Internet is an example of video content space that is becoming a repository and distribution channel for video content. Currently, users wishing to view such content on consumer electronics (CE) devices such as televisions (TVs) encounter several obstacles because content web sites are structured for access via computer screens such as those on a personal computer (PC). Without a pointing device and keyboard, web sites are difficult to navigate on CE devices such as TVs. Further, the layout (font size, etc.) of a web site may not be appropriate for TVs.

In addition, accessing content on such web sites typically involves a delay/gap (at least a few seconds) as content is downloaded and buffered before viewing starts. Some Internet video content services require an entire movie or video segments to be downloaded before the viewer can view the content. These present TV users with either blank screens or download progress bars when users switch between content selections for viewing. In addition, currently much of the Internet video content is in short form (a few minutes in length). Such short form would require TV users to continually make new content selections every few seconds/minutes. There is no smooth transition from one content item to another.

### BRIEF SUMMARY OF THE INVENTION

The present invention provides a method and system for accessing audio/visual content. In one embodiment, such access involves initiating the download of selected content over a communication link, for display on a display device, and monitoring the download status to detect download conditions that may lead to a delay in display of the selected content. Then, upon detecting download conditions that may lead to delay in display of the selected content, displaying alternate available content on the display device.

In one implementation, download of the selected content continues while displaying said available content on the display device. Displaying said available content on the display device continues until a sufficient amount of the selected content is downloaded for display for a certain duration of time. Upon download of sufficient content, a user is prompted to indicate when to cease display of said available content and start displaying the downloaded content.

Selecting available content of interest to the user may further include selecting available content based on information indicating user interests. The available content includes local content and said selected content includes remote content for access via the communication link. The remote content includes Internet video content and the local content includes local video content. The available content includes local available content previously downloaded based on user interests.

These and other features, aspects and advantages of the present invention will become understood with reference to the following description, appended claims and accompanying figures.

### BRIEF DESCRIPTION OF THE DRAWINGS

FIG. 1 shows a functional architecture of a local area network of devices embodying aspects of the present invention.

FIG. 2 shows an example architecture for on-demand Internet video content display which implements a content access function, according to an embodiment of the present invention.

FIG. 3 shows a functional block diagram of a content access module, according to an embodiment of the present invention.

FIG. 4 shows a flowchart of a video content access process, according to an embodiment of the present invention.

### DETAILED DESCRIPTION OF THE INVENTION

The present invention provides a method and system for accessing A/V content, such as accessing video content on the Internet via a communication link. One application of the present invention is for on-demand video services providing Internet/Web videos for download and display on television (TV) sets.

In one embodiment, the present invention provides a content access system for access to Internet video content and display on a display device such as a TV. The content access system provides a TV-like experience by displaying, while downloading, user-selected video content from the Internet, and replacing display delays/gaps that occur as a result of slow Internet content download speeds, with available content (secondary/alternate content) such as content from local storage. As a result, the user need not idly wait while video content is being downloaded from the Internet for display. Instead, in one embodiment, whenever the content access system detects that it is unable to timely download and display user-selected video content without delay, the content access system pauses the selected video playback and instead plays video from the local storage, while continuing a download of the user-selected video, until such time that the content access system has sufficient user-selected video downloaded for display without pause/delay during a time period. The process is repeated as necessary as detected by the content access system.

In one implementation, the content on the local storage may include pre-fetched videos related to user interests and/or related to the original video content selected by the user for viewing. User interest is determined based on user profile or history of user activity for selecting videos stored in the local storage and/or pre-fetching video for the local storage, related to user viewing habits and interests.

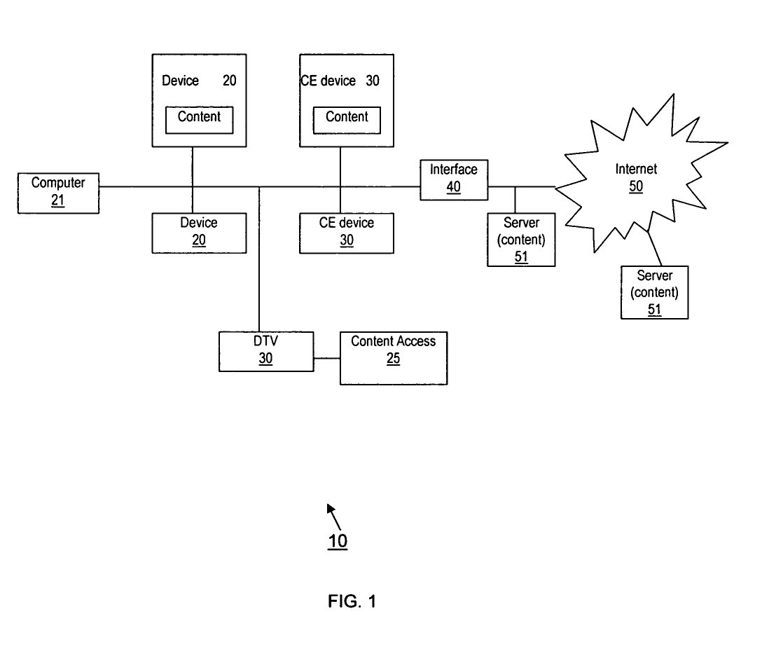

FIG. 1 shows a functional architecture of an example network, such as a local area network (LAN) 10 in a home environment, embodying aspects of the present invention. The network 10 comprises electronic devices 20 (e.g., appliances, databases, storage devices) which may include local content, a PC 21, CE devices 30 (e.g., TV, DTV, PDA, STB, media player) which may include local content, and an interface 40 that connects the network 10 to an external network 50 (e.g., data sources, the Internet). The network 10 may also be connected to one or more servers 51, as shown. Though the example described hereinbelow relates to the CE devices 30, the present invention is equally applicable to other devices. One or more CE devices 30 can implement the Universal Plug and Play (UPnP) protocol for communication therebetween. The present invention is useful with other network communication protocols (e.g., Jini, HAVi, IEEE 1394). Further the network 10 can be a wireless network (e.g., IEEE 802.11), a wired network (e.g., Ethernet, IEEE 1394), or a combination thereof.

The network 10 further provides a content access module 25 that provides access to Internet video content, as described herein. The content access module 25 can function with a standard Internet connection and automatically configures itself for varying connection speeds and video-qualities. The content access module can be implemented as client technology which connects to servers over the Internet for video content and display. The content access module does not require special server support and can therefore operate with a wide-variety of online video services, providing users with the ability to choose between Internet video services.

If the display video bit-rate is higher than the average Internet connection/download speed, then the entirety of the selected video cannot be shown without interruptions. Whenever the content access module 25 detects/perceives such interruption, the content access module pauses the original selected video content being watched by the user, and video from the local storage is started and displayed to the user while the selected video content downloads. As such, the user experiences essentially continuous playback of video content that is either selected by the user or is related to the user interest. Watching an Internet video using the content access module is similar to watching TV where the content program display is essentially continuous.

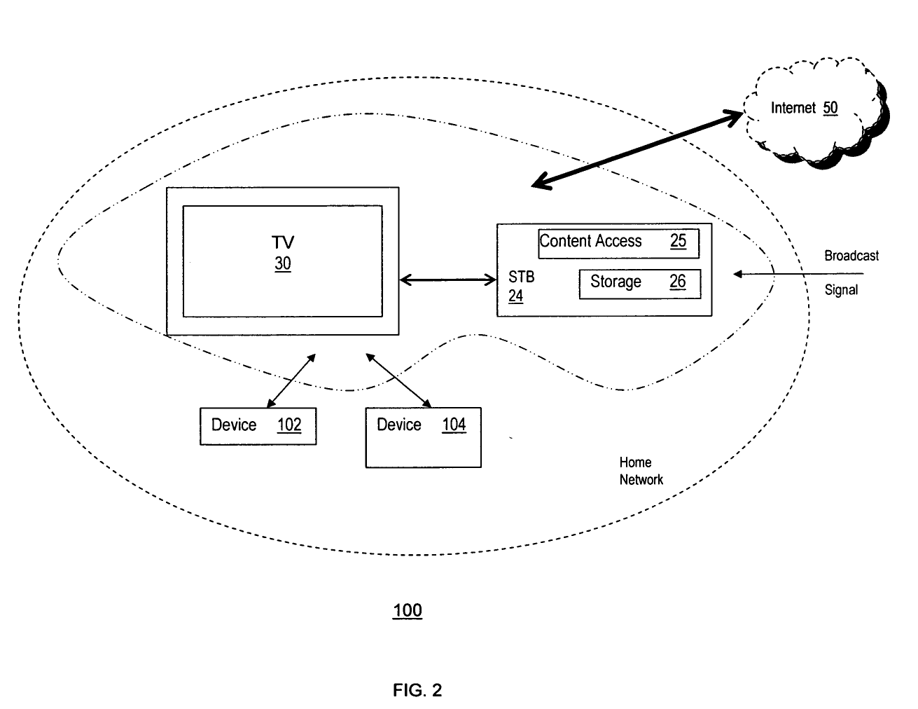

FIG. 2 shows an example home network architecture 100 for on-demand content display which implements a content access function, according to an embodiment of the present invention. A set-top box (STB) 24 implements said content access module 25, wherein the STB 24 further includes storage such as a disk drive for storing local content. The STB 24 can connect to the Internet for downloading Internet video for display on the TV 30. Other devices 102, 104 (e.g., CE devices) in the network can also utilize the functionality of the STB 24 in displaying Internet video content on the TV 30.

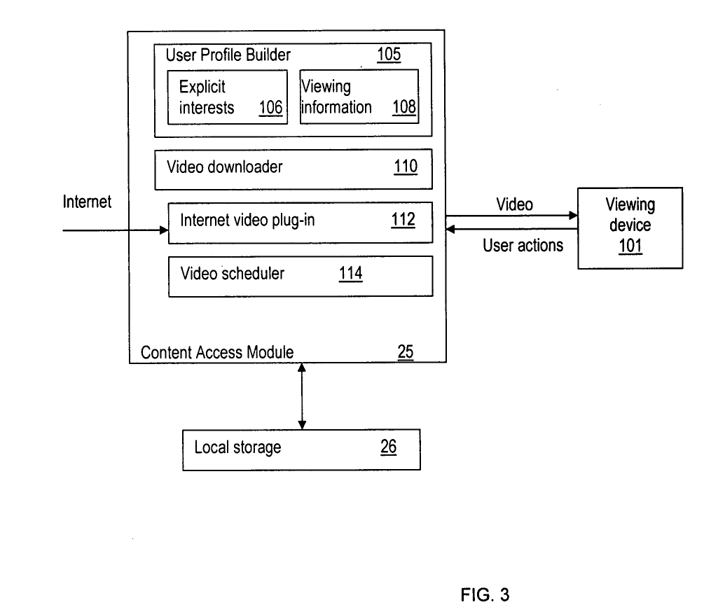

FIG. 3 shows a functional block diagram of an example implementation of the content access module 25 for displaying video on a display device 101, according to an embodiment of the present invention. The content access module 25 comprises sub-modules including a user profile builder 105, a video downloader 110, an Internet video plug-in 112, and a video scheduler 114. Preferably, the video scheduler 114 provides real-time video scheduling functions as described below. The various sub-modules of the content access module 25 can be implemented in one device such as a STB, a TV, etc., or the different sub-modules can be implemented in different devices such as a combination of a TV and a STB.

The user profile builder 105 includes explicit user interests 106 and/or video information 108. The explicit user interests 106 are specified by users. The user profile builder 105 also interprets user viewing interaction with video content (e.g., skip, pause, play, fast-forward, etc.) and video meta-data, and generates a model of the user interests, stored as the viewing information 108.

The video downloader 110 monitors the explicit interests 106 and the viewing information 108, and determines the videos to be downloaded or pre-fetched into the local storage 26 (e.g., flash memory or a disk drive in the network). Based on user interest information from the explicit interests 106 and/or the viewing information 108, the video downloader 110 identifies key terms (e.g., “action”, “drama”, “Louis Armstrong”, “Die Hard”) that may be of interest to the user. The video downloader 110 then uses one or more of the key terms to locate content on the Internet that relates to one or more of the key terms, via the Internet video plug-in 112. The video downloader 110 also provides status information of a video currently being downloaded.

The Internet video plug-in 112 provides information about various sources of Internet videos and provides an interface by which the video downloader 110 can “translate” user profile information to location of videos (e.g., using the plug-in 112 to search for Internet video relating to key terms).

The user may select video content already in the local storage for display on the display device 101, or the user may select video content that needs to be downloaded for display. In either case, the video scheduler 114 monitors the status of the video being watched by the user via the video downloader 110. If the video being watched is in the process of being downloaded, the video scheduler 114 monitors the download process/progress to ensure that the video can be viewed continuously (i.e., without delay/gaps). As soon as the video scheduler 114 detects that the video download is likely to experience a delay (e.g., due to real-time decrease in download speed), the video scheduler 114 selects, and schedules, video content from the local storage 26 for display on the display device 101. The display of video content from the local storage 26 continues until sufficient quantity (e.g., 15 minutes of video) of the download video is available for viewing again. Once the video scheduler 114 detects that sufficient quantity of the download video has become available, the video scheduler 114 waits for the video from the local storage 26 to stop, and then schedules the download video again for display on the display device 101.

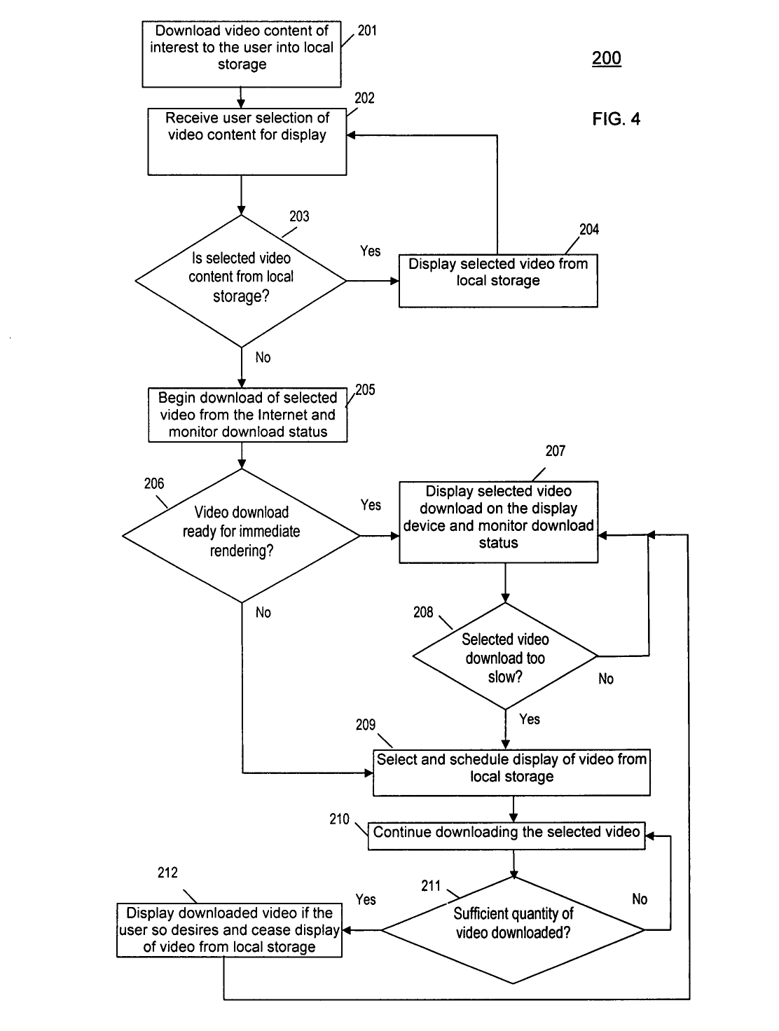

FIG. 4 shows the steps of a video access process 200 implemented in the video access module 25, according to an embodiment of the present invention. The video access process 200 includes the following steps:
Step 201: The video downloader uses the user profile information to download videos of interest to the user into the local storage.
Step 202: Thereafter, the video downloader receives user selection of video content for display.
Step 203: The video downloader determines if the selected video is from the local storage? If yes, go to step 204, otherwise go to step 205.
Step 204: The video scheduler displays video from the local storage on the display device. Go back to step 202.
Step 205: The video downloader begins downloading the selected video from the Internet, and monitors the download status.
Step 206: The video scheduler uses the download status information to detect whether the video can be rendered on the display device immediately? If yes, go to step 207, otherwise go to step 209.
Step 207: The video scheduler displays the download video on the display device and continues monitoring the download status.
Step 208: Based on the monitored status, the video scheduler determines if the download speed is too slow for continuous viewing? If not, go back to step 207, otherwise go to step 209.
Step 209: The video scheduler selects, and schedules, display of a video from the local storage.
Step 210: The video downloader continues downloading the user selected video from the Internet, and the video scheduler continues monitoring the video download status.
Step 211: The video scheduler determines if sufficient quantity of the selected video has been downloaded? If yes, go to step 212, otherwise go back to step 210.
Step 212: The video scheduler displays the downloaded video if the user so desires and ceases display of video from the local storage. For example, the video scheduler informs the user that he/she can continue to watch the current video display from the storage, or can view the selected downloaded video. Go back to step 207.

In one embodiment, the scheduled video is chosen based on the following parameters: (a) whether it was viewed by the user before, (b) whether it is relevant to the video chosen for viewing, and (c) how long is the video. In another embodiment, based on download speed, the amount of time before the original video can be viewed is estimated, and a video of appropriate length based on said time estimate is selected from the local storage.

Accordingly, an on-demand video service can provide essentially continuous playback of video content on a device that connects to the Internet for content download over a range of connection speeds and video data rates. The user is provided with essentially continuous video content playback (a TV-like experience) without requiring the user to wait for Internet video content or TV channels to download. The user need not stay idle or wait for a portion of a video content item to be downloaded before it can be displayed. This is because the content access system displays content from local storage while a selected Internet video content item is being downloaded for display.

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof; however, other versions are possible. Therefore, the spirit and scope of the appended claims should not be limited to the description of the preferred versions contained herein.

What is claimed is:

1. A method for accessing audio/visual content, comprising:
initiating a download of selected content over a communication link, for display on a display device;
monitoring the download status to detect download conditions that may lead to a delay in the display of the selected content; and
upon detecting download conditions that may lead to delay in display of the selected content, displaying alternate available content on the display device.

2. The method of claim 1 further including:
while displaying said available content on the display device, continuing download of the selected content.

3. The method of claim 2 further including:
displaying said available content on the display device until a sufficient amount of the selected content is downloaded for display for a certain duration of time.

4. The method of claim 3 further including:
upon download of sufficient content, ceasing display of said available content, and displaying the downloaded content.

5. The method of claim 4 further including:
upon download of sufficient content, prompting a user when to cease display of said available content and start displaying the downloaded content.

6. The method of claim 1, wherein displaying available content on the display device further includes selecting available content of interest to the user, and displaying the selected available content.

7. The method of claim 6, wherein selecting available content of interest to the user further includes selecting available content based on information indicating user interests.

8. The method of claim 1, wherein said available content includes content that can be displayed without delay.

9. The method of claim 8, wherein said available content includes local content and said selected content includes remote content for access via the communication link.

10. The method of claim 9, wherein the remote content includes Internet video content and the local content includes local video content.

11. The method of claim 9, wherein the available content includes local available content previously downloaded based on user interests.

12. An apparatus for accessing audio/visual content, comprising:
a downloader configured for downloading selected content over a communication link, for display on a display device; and
a scheduler configured for detecting download conditions that may lead to a delay in the display of the selected content, and upon such detection, displaying available content on the display device.

13. The apparatus of claim 12, wherein:
the downloader is further configured for continuing the download of the selected content, while said available content is being displayed.

14. The apparatus of claim 13, wherein:
the scheduler is configured for displaying said available content on the display device until a sufficient amount of the selected content is downloaded for display for a certain duration of time.

15. The apparatus of claim 13, wherein the scheduler is further configured such that upon the download of sufficient content, the scheduler ceases display of said available content, and displays the downloaded content.

16. The apparatus of claim 13, wherein the scheduler is further configured such that, upon the download of sufficient selected content, the scheduler prompts a user to determine when to cease display of said available content and start displaying the downloaded content.

17. The apparatus of claim 12, wherein the scheduler is further configured for selecting available content of interest to the user, and displaying the selected available content.

18. The apparatus of claim 17, wherein the scheduler is further configured for selecting available content of interest to the user by selecting available content based on information indicating user interests.

19. The apparatus of claim 12, wherein said available content includes content that can be displayed without delay.

20. The apparatus of claim 19, wherein said available content includes local content and said selected content includes remote content for access via a communication link.

21. The apparatus of claim 20, wherein the remote content includes Internet video content and the local content includes local video content.

22. The apparatus of claim 20, wherein the available content includes local available content previously downloaded based on user interests.

23. A client module for accessing audio/visual content, comprising:
a user profiler configured for obtaining user interest information;
a downloader configured for downloading selected content from a server over a communication link, for display on a display device; and
a scheduler configured for detecting download conditions that may lead to a delay in the display of the selected content, and upon such detection, selecting available content based on the user interest information and displaying the selected available content on the display device.

24. The client module of claim 23 wherein:
the downloader is further configured for continuing the download of the selected content, while said available content is being displayed.

25. The client module of claim 24 wherein:
the scheduler is configured for displaying said available content on the display device until a sufficient amount of the selected content is downloaded for display for a certain duration of time.

26. The client module of claim 24, wherein the scheduler is further configured such that upon download of sufficient content, the scheduler ceases display of said available content, and displays the downloaded content.

27. The client module of claim 24, wherein the scheduler is further configured such that, upon the download of sufficient selected content, the scheduler prompts a user to determine when to cease display of said available content and start displaying the downloaded content.

28. The client module of claim 23, wherein said available content includes content that can be displayed without delay.

29. The client module of claim 28, wherein said available content includes local content and said selected content includes remote content for access via the communication link.

30. The client module of claim 29, wherein the remote content includes Internet video content and the local content includes local video content.

31. The client module of claim 29, wherein the available content includes local available content previously downloaded based on user interest information.

32. The client module of claim 24, wherein the scheduler is further configured for estimating duration of the delay, and selecting available content for display further based on the estimated duration of the delay.
